(19) United States
(12) Patent Application Publication
(10) Pub. No.: US 2026/0066154 A1
(43) Pub. Date: Mar. 5, 2026

(54) METHOD FOR PREPARING FLAME-RETARDANT MAGNETIC WIRE AND WIRE

(71) Applicant: Beijing Magvalley Technology Co., Ltd., Beijing (CN)

(72) Inventor: Guilan WANG, Beijing (CN)

(73) Assignee: Beijing Magvalley Technology Co., Ltd., Beijing (CN)

(21) Appl. No.: 19/029,916

(22) Filed: Jan. 17, 2025

(30) Foreign Application Priority Data
Sep. 5, 2024 (CN) 202411243568.6

(51) Int. Cl. H01B 13/14; H01B 13/22; H01F 1/059

(52) U.S. Cl. CPC H01B 13/14; H01B 13/22; H01F 1/059

(57) ABSTRACT

A method for preparing a flame-retardant magnetic wire and the wire are provided. The material for flame-retardant magnetic layer is obtained by compounding rare earth iron nitrogen (R—Fe—N) magnet powder with ferrite magnet powder and adding an elastic substrate and a flame retardant. The core and the material for flame-retardant magnetic layer are co-extruded and shaped, and the wire is obtained after magnetization. The wire preparation solution with the least addition of flame retardant, the highest magnetic attraction performance and the best mechanical properties can be realized. The prepared wire has good flexibility, good tear resistance and tensile properties.

### TECHNICAL FIELD

The disclosure relates to the technical field of wires and their preparation, and in particular to a wire with a magnetic adsorption function and a flame retardant effect, which can be used in the preparation of data lines, power lines, signal lines and other fields.

### BACKGROUND

Wires, including data cables, signal cables, power cables, etc., are widely used in household appliances and consumer electronics. For ease of use, wires used in these fields must have a certain length, usually 0.9 m or longer. How to store them conveniently is a common problem with traditional wires.

After the flexible bonded magnet is prepared by magnetic materials and polymer compounds such as elastomer materials, a magnetic field is generated in its orientation and/or magnetization direction, thereby generating a magnetic attraction force between opposite poles. By utilizing the above characteristics of magnetic materials, the above flexible bonded magnet is added to the wire structure, which makes it possible to conveniently store the wire. As the requirements for material safety and environmental protection are increasingly higher in many countries, it has become a mandatory requirement for wires to achieve low-smoke flame retardancy, especially halogen-free low-smoke flame retardancy, especially in the field of household appliances and consumer electronics. Therefore, wires with magnetic attraction function should also have flame retardant properties.

Prior arts disclose some technical solutions for magnetic wires. The patent for invention CN113674921B, with a title of “a method for preparing an automatically-curling and freely-stretching magnetic data line”, discloses a magnetic wire comprising a middle flexible permanent magnetic covering layer, which is a flexible covering layer of a modified polymer composite material comprising a permanent magnetic material samarium iron nitrogen magnet powder, a binder and an additive. The median particle size D50 of the samarium iron nitrogen magnet powder is 1˜5 μm in the case of anisotropic samarium iron nitrogen magnet powder, and 5˜50 μm in the case of isotropic samarium iron nitrogen magnet powder. The permanent magnetic covering layer comprises the following components in weight percentages: 85˜93% of permanent magnetic material powder, 7˜16% of binder, and 0˜5% of processing aid. The permanent magnetic covering layer produced by this method does not have a flame retardant function, but it is proposed to add a flame retardant to the outer sheath layer of the wire. However, this is obviously difficult to achieve, or even impossible to achieve the flame retardant effect of the entire wire according to the current flame retardant test standards, and does not meet the safety standards of various countries. In addition, the anisotropic samarium iron nitrogen magnet powder used in this patent has the D50 particle size of 1˜5 μm. However, when the D50 of the anisotropic samarium iron nitrogen magnet powder is greater than 3 μm, the magnetic properties of the anisotropic samarium iron nitrogen magnet powder are low, resulting in that the magnetic attraction force of the wire is not high, and the mechanical properties are poor. The magnetic layer of this patent only uses samarium iron nitrogen magnet powder, which is not conducive to achieving the optimal combination of flame retardant effect, magnetic attraction effect and mechanical properties. Furthermore, this patent does not achieve halogen-free, which does not meet the environmental protection requirements of some countries.

The utility model patent CN217036223U with a title of “a data cable” discloses a data cable, in which the material for the middle sheath layer of the cable includes samarium iron nitrogen magnet powder, and a heat-resistant shielding layer is set on the inner and outsides of the middle sheath layer, which attends to solve the problem that samarium iron nitrogen magnet powder is very easy to oxidize and burn, resulting in that the cable has the weak overall flame retardancy. It can be seen that the middle sheath layer of samarium iron nitrogen magnet powder used in this patent has no flame retardant function and does not contain flame retardants. Furthermore, halogen-free is not mentioned.

It is a mandatory legal requirement for wires, especially data cables and charging cables, to be flame retardant. Magnet powders, especially anisotropic samarium iron nitrogen magnet powders, are submicron-sized magnet powders. Based on their molecular formula (Sm₂Fe₁₇N₃), they have a high metallic iron content and are flammable. In order to ensure the magnetic and mechanical properties, too much flame retardant cannot be added. Therefore, it is a difficult problem to achieve flame retardancy magnetic wires, which must be solved.

### SUMMARY

The object of the disclosure is to provide a wire having magnetic attraction and flame retardant functions and a method for preparing the same, so as to realize the convenient storage of wires such as data cables, signal cables, and power cables.

The first aspect of the disclosure provides a method for preparing a flame-retardant magnetic wire, wherein the flame-retardant magnetic wire is provided with a core, a middle sheath layer and an optional outer sheath layer from inside to outside, the middle sheath layer is a flame-retardant magnetic layer, and the method for preparing the wire comprises:
(1) co-extruding a core and a material for the flame-retardant magnetic layer to obtain a core coated with the flame-retardant magnetic layer, wherein the material for the flame-retardant magnetic layer comprises an elastic substrate, a magnetic material and a flame retardant; wherein the magnetic material comprises a rare earth iron nitrogen magnet powder, preferably, the magnetic material comprises a rare earth iron nitrogen magnet powder and a ferrite magnet powder;
optionally, forming an outer sheath layer on the outside of the core coated with the flame-retardant magnetic layer;
(2) shaping the wire obtained in step (1);
(3) magnetizing the wire obtained in step (2) to obtain the flame-retardant magnetic wire;
furthermore, in the material for the flame-retardant magnetic layer, the content of the elastic substrate is 15 wt %˜25 wt %, the content of the magnetic material is 55 wt %˜75 wt %, and the content of the flame retardant is 5 wt %˜15 wt %.

According to the method of the first aspect, the rare earth iron nitrogen magnet powder is a samarium iron nitrogen magnet powder and/or a neodymium iron nitrogen magnet powder;
furthermore, the samarium iron nitrogen magnet powder has a D50 of 1.9-3 μm, the neodymium iron nitrogen magnet powder has a D50 of 1.5-1.9 μm, and the ferrite magnet powder has a D50 of 1.5-1.8 μm; and/or
furthermore, the samarium iron nitrogen magnet powder, the neodymium iron nitrogen magnet powder and/or the ferrite magnet powder are anisotropic;
furthermore, in the magnetic material, the mass ratio of the rare earth iron nitrogen magnet powder to the ferrite magnet powder is (0.5-1):(0-0.5), and furthermore (0.5-0.9):(0.1-0.5).

According to the method of the first aspect, in step (1), the extruder head adopted during the extrusion molding is oriented by a permanent magnet or at an electromagnetic field;
furthermore, the magnetic field strength for orienting by the permanent magnet is 8000˜13000 Oe; or furthermore, the magnetic field strength for orienting at the electromagnetic field is ≥13000 Oe.

According to the method of the first aspect, the elastic substrate in the material for the flame-retardant magnetic layer is:
polyvinyl chloride (PVC), furthermore, the polyvinyl chloride (PVC) having a hardness of 40-100 A;
silicone rubbers, furthermore, the silicone rubbers having a hardness of 40-70 A; and/or
thermoplastic elastomers, furthermore, the thermoplastic elastomer having a melting point of 80˜200° C., and more preferably selected from the group consisting of styrene-based thermoplastic elastomers, olefin-based thermoplastic elastomers, diene-based thermoplastic elastomers, vinyl chloride-based thermoplastic elastomers, urethane-based thermoplastic elastomers (TPU), ester-based thermoplastic elastomers (TPEE), amide-based thermoplastic elastomers (TPAE), thermoplastic resins (EEA), thermoplastic vulcanizate (TPV) and silicone-based thermoplastic elastomers, and more preferably one or more halogen-free materials selected from the group consisting of TPEE, TPU, TPV, and TPAE.

According to the method of the first aspect, the flame retardant in the material for the flame-retardant magnetic layer is selected from organic flame retardants and/or inorganic flame retardants, preferably halogen-free flame retardants;
furthermore, the material for the flame-retardant magnetic layer further comprises a processing aid comprising one or more of a coupling agent, a plasticizer, a toughening agent, a lubricant, and an antioxidant.

According to the method of the first aspect, in step (1), the magnetic material is surface-modified with a coupling agent;
furthermore, the coupling agent is a silane coupling agent or a titanate coupling agent;
furthermore, the magnetic material is modified at 80-150° C. by using a coupling agent in an amount of 0.2-2 wt % of the total weight of the magnetic material.

According to the method of the first aspect, in step (1), the outer sheath layer material is selected from one or more of a woven material, TPU, TPEE, TPV, and a silicone rubber, and the woven material is preferably a flame-retardant woven material, and more preferably one or more of flame-retardant chinlons, flame-retardant nylons, and flame-retardant aramids.

According to the method of the first aspect, in step (1), the extrusion molding is performed by a single screw wire extruder with a permanent magnet oriented extruder head;
preferably, the extrusion speed is ≥30 m/s;
preferably, when the elastic substrate is a silicone rubber, the extruder and the die head are at room temperature;
preferably, the elastic substrate is a thermoplastic elastomer, and the screw temperature of each section of the extruder is 100-200° C.; and/or
preferably, when the elastic substrate is the thermoplastic elastomer, the extruder die temperature is 120-200° C.

According to the method of the first aspect, in step (2), when the elastic substrate is a thermoplastic elastomer, the shaping is performed by baking at 200-300° C.;
in step (2), when the elastic substrate is a silicone rubber, the shaping is performed by vulcanization through a heating channel at a temperature of 200 to 400° C.; and/or
in step (3), the wire is magnetized in a curled state by using a spiral coil magnetizing device with a magnetic field strength of more than 35000 kOe or in a flat state by using a groove magnetizing device.

The second aspect of the disclosure provides a flame-retardant magnetic wire prepared by the method of the first aspect;
preferably, the Shore hardness of the wire is ≤90 A;
preferably, the flame retardance rating of the wire meets VW−1;
preferably, the wire is halogen-free; and/or
preferably, the surface magnetic field strength of the wire in the magnetization direction is above 500 Gs.

According to the flame-retardant magnetic wire material of the second aspect, the thickness of middle sheath layer of the wire is 0.3-2 mm, preferably 0.3-1 mm, and/or the thickness of the outer sheath layer of the wire is ≤1 mm, preferably ≤0.3 mm;
preferably, the core of the wire comprises a single conductor coated with an insulation layer or multiple conductors individually coated with an insulation layer;
more preferably, a fiber material is further arranged inside the core of the wire, and the fiber material is selected from one or more of glass fibers, basalt fibers, and aramid fibers;
further preferably, a shielding layer is provided between the core and the middle sheath layer of the wire, and the shielding layer wraps the conductor and the fiber material.

The method for preparing the flame-retardant magnetic wire of the disclosure has, but is not limited to, the following beneficial effects:

The method of the disclosure, in which anisotropic rare earth iron nitrogen magnet powders are used and further compounded with ferrite magnet powder, and a die head with a magnetic field orientation function is used to extrude wire, without setting a heat-resistant shielding layer, can realize the current wire preparation solution with the least addition of flame retardant, the highest magnetic attraction performance, and the best mechanical properties. The prepared wire has good flexibility, good tear resistance and tensile properties. The excellent flame retardant properties can be maintained when the addition amount of the flame retardant is reduced, and the wire having high magnetic properties can be obtained.

### BRIEF DESCRIPTION OF THE DRAWINGS

FIG. 1 shows a schematic cross-sectional view of the flame-retardant magnetic wire (without a shielding layer) of the disclosure.

FIG. 2 shows a schematic cross-sectional view of the flame-retardant magnetic wire (with a shielding layer) of the disclosure.

FIG. 3 shows a schematic diagram of the magnetic field orientation device (permanent magnet orientating) for the extrusion head of the extrusion mechanism of the disclosure.

FIG. 4 shows a schematic cross-sectional view of the magnetic field orientation device (permanent magnetic orientating) for the extrusion head of the extrusion mechanism of the disclosure.

FIG. 5 shows a schematic diagram of the magnetic field orientation device (electromagnetic orientation) for the extruder head of the disclosure.

FIG. 6 shows a schematic diagram of a magnetization scheme for the flame-retardant magnetic wire of the disclosure.

FIG. 7 shows a schematic diagram of the flame-retardant magnetic wire storage effect of the disclosure.

### DESCRIPTION OF REFERENCE NUMERALS

1. core; 11. conductor; 2. middle sheath layer; 3. outer sheath layer; 4. shielding layer; 5. magnetic field orientation device; 51. magnetizers; 52. permanent magnet; 53. wire outlet port; 54. extrusion channel; 55. magnetic field core mold; 6. electromagnet; 61. magnetic pole head; 62. soft iron pole; 63. yoke iron; 64. coil; 7. solenoid cylinder; 8. wire to be magnetized; 9. magnetizing machine; 10. clamp.

### DETAILED DESCRIPTION

The present application is further described in detail below through the accompanying drawings and embodiments. Through these descriptions, the characteristics and advantages of the present application will become clearer and more specific.

The wording “exemplary” is used exclusively herein to mean “serving as an example, embodiment, or illustration.” Any embodiment described herein as “exemplary” is not necessarily to be construed as preferred or advantageous over other embodiments. Although various aspects of the embodiments are shown in the drawings, the drawings are not necessarily drawn to scale unless otherwise noted.

In addition, the technical features involved in different embodiments of the present application described below can be combined with each other as long as they do not conflict with each other.

The disclosure provides a method for preparing a flame-retardant magnetic wire, wherein the flame-retardant magnetic wire is provided with a core, a middle sheath layer and an optional outer sheath layer from inside to outside, the middle sheath layer is a flame-retardant magnetic layer, and
the method for preparing the wire comprises:
(1) co-extruding a core and a material for the flame-retardant magnetic layer to obtain a core coated with the flame-retardant magnetic layer, wherein the material for the flame-retardant magnetic layer comprises an elastic substrate, a magnetic material and a flame retardant; wherein the magnetic material comprises a rare earth iron nitrogen magnet powder, preferably, the magnetic material comprises a rare earth iron nitrogen magnet powder and a ferrite magnet powder;
optionally, forming an outer sheath layer on the outside of the core coated with the flame-retardant magnetic layer;
(2) shaping the wire obtained in step (1);
(3) magnetizing the wire obtained in step (2) to obtain the flame-retardant magnetic wire.

Furthermore, in the material for the flame-retardant magnetic layer, the content of the elastic substrate is 15 wt %˜25 wt %, the content of the magnetic material is 55 wt %˜75 wt %, and the content of the flame retardant is 5 wt %˜15 wt %. In a preferred embodiment, the content of the elastic substrate is 15 wt %-20 wt %, the content of the magnetic material is 65 wt %-75 wt %, and the content of the flame retardant is 5 wt %-10 wt %.

Rare earth iron nitrogen (R—Fe—N) materials are a type of permanent magnetic materials containing rare earth elements, having a chemical formula of RₐFe_{b}N_{c}, wherein R is a rare earth element, selected from one or more of samarium Sm, neodymium Nd, lanthanum La, cerium Ce, praseodymium Pr, promethium Pm, gadolinium Gd, terbium Tb, dysprosium Dy, europium Eu, holmium Ho, erbium Er, thulium Tm, ytterbium Yb, lutetium Lu, yttrium Y, and scandium Sc, and a, b, and c are non-zero natural numbers. The rare earth iron nitrogen magnet powder of the disclosure may be samarium iron nitrogen magnet powder, neodymium iron nitrogen magnet powder, and the like. Among them, samarium iron nitrogen may be Sm₂Fe₁₇Nₓ having a Th₂Zn₁₇ type rhombohedral crystal structure, and neodymium iron nitrogen may be NdFe₁₂Nₓ having a ThMn₁₂ type tetragonal crystal structure. Compared with rare earth permanent magnet materials such as samarium cobalt magnet materials and neodymium iron boron magnet materials, the rare earth iron nitrogen permanent magnet materials have better magnetic properties and particle size characteristics, and also have excellent anti-oxidation and anti-corrosion properties.

In order to achieve a good flame retardant effect, it is common in the prior art to increase the amount of the flame retardants in the composite materials. However, in the field of magnetic wires, excessive addition of flame retardants is not only not conducive to maintaining the flexibility and toughness of the material, but also greatly reduces the magnetic performance. In the technical solution of the disclosure, adding ferrite magnet powder can not only reduce the loss of magnetic properties, but also can achieve flame retardant properties with less addition of flame retardants because of the characteristics of the ferrite magnet powder itself. In one embodiment, the rare earth iron nitrogen magnet powder is samarium iron nitrogen magnet powder and/or neodymium iron nitrogen magnet powder;
Furthermore, the samarium iron nitrogen magnet powder has a D50 of 1.9-3 μm, the neodymium iron nitrogen magnet powder has a D50 of 1.5-1.9 μm, and the ferrite magnet powder has a D50 of 1.5-1.8 μm; and/or
furthermore, the samarium iron nitrogen magnet powder, the neodymium iron nitrogen magnet powder and/or the ferrite magnet powder are anisotropic.

Furthermore, in the magnetic material, the mass ratio of the rare earth iron nitrogen magnet powder to the ferrite magnet powder is (0.5-1):(0-0.5), and further, the mass ratio of the rare earth iron nitrogen magnet powder to the ferrite magnet powder is (0.5-0.9):(0.1-0.5).

The magnetic material of the disclosure can select the isotropic or anisotropic magnet powder. Further, the magnetic material powder is an anisotropic samarium iron nitrogen powder with a D50 of 1.9 to 3 μm and/or an anisotropic neodymium iron nitrogen powder with a D50 of 1.5 to 1.9 μm, which can be further compounded with an anisotropic ferrite magnet powder to achieve the effects of improving the flame retardant and magnetic performances. The anisotropic rare earth iron nitrogen magnet powder can achieve high magnetic properties that other magnet powders on the market do not have under orientation conditions, and at the same time has good properties such as corrosion resistance, rust resistance, aging resistance, and oxidation resistance due to the characteristics of nitrides. In addition, based on the particle size characteristics of the samarium iron nitrogen magnet powder having a D50 between 1.9 and 3 μm, the neodymium iron nitrogen magnet powder having a D50 between 1.5 and 1.9 μm, and the ferrite magnet powder having a D50 between 1.5-1.8 μm, they can be well combined with common elastomeric materials, so that the obtained wire has good flexibility while also having good tear resistance and tensile properties. When the anisotropic rare earth iron nitrogen magnet powder has a too large D50 (>3 μm), the anisotropic rare earth iron nitrogen magnet powder has a low magnetic property, and as a result the produced wire does not have a high magnetic attraction force, and has poor mechanical properties.

In one embodiment, the mass ratio of the rare earth iron nitrogen magnet powder to the ferrite magnet powder in the magnetic material is (0.5˜1):(0˜0.5). By adjusting the appropriate ratio of the magnet powders to the flame retardants in the flame retardant magnetic layer, the obtained wire has excellent magnetic absorption performance, flame retardant performance and mechanical properties. In a specific embodiment, the mass ratio of the rare earth iron nitrogen magnet powder to the ferrite magnet powder in the magnet powder is (0.5˜0.9):(0.1˜0.5). When the content of the ferrite magnet powder is too high, the magnetic properties of the produced middle coating layer are too low to meet the requirements of the wire for magnetic attraction force.

In one embodiment, in step (1), during the extrusion molding, the extruder head adopted during the extrusion molding is oriented by a permanent magnet or an electromagnetic field.

Further, the magnetic field strength for orienting by the permanent magnet is 8000˜13000 Oe.

Furthermore, the magnetic field strength for orienting at the electromagnetic field is ≥13000 Oe.

In one embodiment, the elastic substrate in the material for the flame-retardant magnetic layer is:
polyvinyl chloride (PVC), preferably, the polyvinyl chloride (PVC) having a hardness of 40-100 A;
silicone rubbers, preferably, the silicone rubbers having a hardness of 40-70 A; or
thermoplastic elastomers, preferably, the thermoplastic elastomer having a melting point of 80˜200° C., and more preferably selected from the group consisting of styrene-based thermoplastic elastomers (SBS, SIS, SEBS, SEPS), olefin-based thermoplastic elastomers (TPO, TPV), diene-based thermoplastic elastomers (TPB, TPI), vinyl chloride-based thermoplastic elastomers (TPVC, TCPE), urethane-based thermoplastic elastomers (TPU), ester-based thermoplastic elastomers (TPEE), amide-based thermoplastic elastomers (TPAE), thermoplastic resins (EEA, ethylene-ethyl acrylate copolymer), thermoplastic vulcanizate (TPV) and silicone-based thermoplastic elastomers, and more preferably one or more halogen-free materials selected from the group consisting of TPEE, TPU, TPV, and TPAE.

In one embodiment, the flame retardant in the material for the flame-retardant magnetic layer is selected from the group consisting of the organic flame retardants and/or the inorganic flame retardants, preferably halogen-free flame retardants.

Furthermore, the material for the flame-retardant magnetic layer also comprises a processing aid comprising one or more of a coupling agent, a plasticizer, a toughening agent, a lubricant, and an antioxidant.

The elastic substrate can be selected from one or more of PVC, silicone rubbers, and thermoplastic elastomers, wherein PVC has the hardness of 40-100 A, for example, 40 A, 50 A, 60 A, 70 A, 80 A, 90 A, 100 A, the silicone rubbers have the hardness of 40-70 A, for example, 40 A, 50 A, 60 A, 70 A, and the thermoplastic elastomer preferably is the thermoplastic elastomer materials with a melting point between 80° C. and 200° C., for example, 80° C., 100° C., 120° C., 150° C., 180° C., and 200° C. The use of these elastomers can achieve the following effects: the material has good flexibility and good molding fluidity, is halogen-free, and meets safety and environmental standards. If the selected thermoplastic elastomer has a too low melting point, the mechanical properties of the resulting wire will be poor. If the selected thermoplastic elastomer has a too high melting point, the high temperature during processing will lead to a loss of magnetic properties, and the resulting wire will not be able to achieve high magnetic properties.

The flame retardant of the disclosure may be an organic flame retardant or an inorganic flame retardant. Organic flame retardants include, but not limited to, flame retardants with bromine, chlorine, phosphorus-nitrogen, nitrogen, red phosphorus and compounds as main components. Inorganic flame retardants include, but are not limited to, flame retardants with antimony trioxide, magnesium hydroxide, aluminum hydroxide, etc. as main components. The flame retardant may contain halogen or not contain halogen, preferably halogen-free flame retardants.

The coupling agent, plasticizer, toughening agent and lubricant in the processing aids can be conventional materials and can be selected according to needs.

In one embodiment, in step (1), the magnetic material is surface-modified by a coupling agent. Furthermore, the coupling agent is a silane coupling agent or a titanate coupling agent. Furthermore, the magnetic material is modified at 80-150° C. by using a coupling agent in an amount of 0.2-2 wt % of the total weight of the magnetic material.

In a specific embodiment, the magnetic material is surface modified by mixing with 0.5-2 wt % of a coupling agent, and stirring at a temperature between 80° C. and 150° C. and drying.

The disclosure utilizes a coupling agent to perform surface modification on the magnetic material, thereby increasing the fluidity of the magnetic material powders and improving the bonding effect between the magnetic material powders and the elastomer material, thereby ensuring the orientation effect of the magnetic material in a magnetic field and the flexibility of the material.

In a specific embodiment, the material for the flame retardant magnetic layer is prepared into a granular material and then is used to prepare the middle sheath layer.

In one embodiment, in step (1), the outer sheath layer material is selected from one or more of a woven material, TPU, TPEE, TPV, and a silicone rubber, and the woven material is preferably a flame-retardant woven material, and more preferably one or more of flame-retardant chinlons, flame-retardant nylons, and flame-retardant aramids.

In one embodiment, in step (1), the extrusion molding is performed by a single screw wire extruder with a permanent magnet oriented extruder head. Further, the extrusion speed is >30 m/s. Furthermore, when the elastic substrate is a silicone rubber, the extruder and the die head are at room temperature. Furthermore, when the elastic substrate is a thermoplastic elastomer, the temperature of each section of the screw of the extruder is 100-200° C. Furthermore, when the elastic substrate is a thermoplastic elastomer, the extruder die head temperature is 120-200° C.

When the temperature of the extruder die head is too high, high temperature demagnetization may occur.

In one embodiment, in step (2), when the elastic substrate is a thermoplastic elastomer, the shaping is performed by baking at 200-300° C.;
in step (2), when the elastic substrate is a silicone rubber, the shaping is performed by vulcanization through a heating channel at a temperature of 200 to 400° C.; and/or
in step (3), the wire is magnetized in a curled state by using a spiral coil magnetizing device with a magnetic field strength of more than 35000 kOe or in a flat state by using a groove magnetizing device.

The disclosure also provides a flame-retardant magnetic wire, which is prepared by the above method. Furthermore, the Shore A hardness of the wire is ≤90 A, that is, the Shore A hardness of the wire of the disclosure does not exceed 90 degrees;
furthermore, the flame retardance rating of the wire reaches VW−1;
furthermore, the wire is halogen-free; and/or
furthermore, the surface magnetic field strength of the wire in the magnetization direction is above 500 Gs.

In one embodiment, the thickness of the middle sheath layer of the wire is 0.3-1 mm, and/or the thickness of the outer sheath layer of the wire is ≤0.3 mm;
furthermore, the core of the wire comprises a single conductor coated with an insulation layer or multiple conductors individually coated with an insulation layer;
furthermore, a fiber material is further arranged inside the core of the wire, and the fiber material is selected from one or more of glass fibers, basalt fibers, and aramid fibers;
furthermore, a shielding layer is provided between the core and the middle sheath layer of the wire, and the shielding layer wraps the conductor and the fiber material.

The flame-retardant magnetic wire prepared by the disclosure consists of a core, a middle sheath layer and an outer sheath layer from inside to outside.

The core is composed of a single conductor coated with an insulation layer or multiple conductors individually coated with an insulation layer, which can be twisted or arranged in parallel. Fiber materials such as glass fiber, basalt fiber, and aramid can be added to the core to enhance the tensile and heat dissipation performance. The core and fiber can be wrapped with materials such as aluminum foils as a shielding layer.

The middle sheath layer is a flame retardant magnetic layer, which is prepared from an elastic substrate, magnetic material powders, a flame retardant, and at least one of a coupling agent, a plasticizer, a toughening agent, a lubricant, and an antioxidant, preferably a halogen-free material. The thickness of the middle sheath layer is preferably 0.3-1 mm.

The outer sheath layer can be wrapped with woven materials (preferably flame-retardant woven materials, including but not limited to flame-retardant chinlons, flame-retardant nylons, flame-retardant aramids, etc.), TPU, TPEE, TPV, silicone rubbers and other materials. If woven materials are selected, glue can also be directly applied on the weaving. The thickness of the outer sheath layer is preferably not more than 0.3 mm, and the outer sheath layer material is preferably halogen-free.

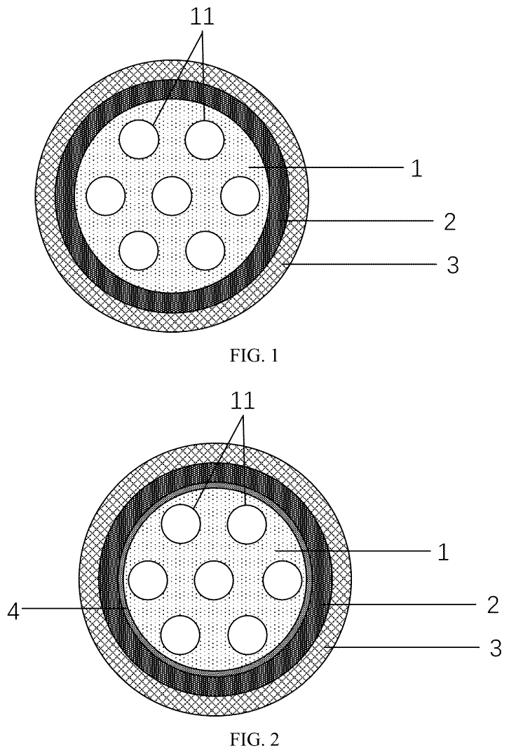

FIG. 1 shows a cross-sectional schematic diagram of the wire of the disclosure, which includes the core 1, the middle sheath 2, and the outer sheath 3 from inside to outside. The core 1 includes a plurality of conductors 11. The core may include fiber materials to improve the mechanical properties and heat dissipation performance of the wire. As shown in FIG. 2, the shielding layer 4 may be wrapped around the outside of the core.

After preparation, the wire preferably has the outer diameter of not more than 5 mm in thickness/width/diameter, the Shore hardness of ≤90 A, and the flame retardance rating of VW−1.

In a specific embodiment, the preparation method comprises:
mixing the following components in the following proportions:
55 wt %-75 wt % of the magnet powders,
15 wt %-25 wt % of the elastomeric material,
10 wt %-30 wt % of the processing aids, including 5 wt %-15 wt % of flame retardants.

The magnetic particles are prepared by using a twin-screw extruder at the screw temperature of each section of 100-200° C.

The flame retardant magnetic wire is extruded by using a single screw wire extruder and an extruder head with magnetic field orientation. The wire cross-section is round, oblate or rectangular, and the extrusion speed is ≥30 m/s. The screw temperature of each section of the extruder is 100-200° C., and the die temperature is 120-200° C. The adopted extruder head is oriented by a permanent magnet or an electromagnetic field. In the case of permanent magnet, the magnetic field strength for orientating (the orientation field) is 8000˜13000 Oe. in the case of electromagnetic field, the orientation field is ≥13000 Oe.

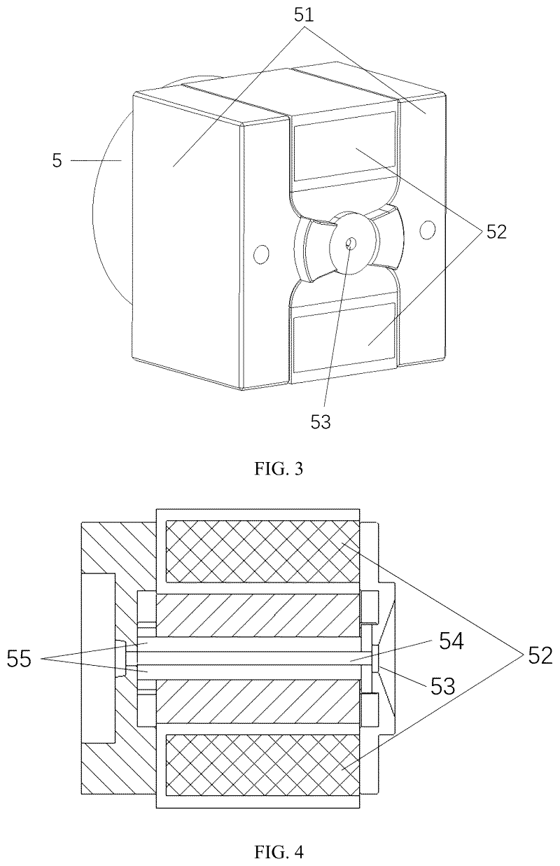

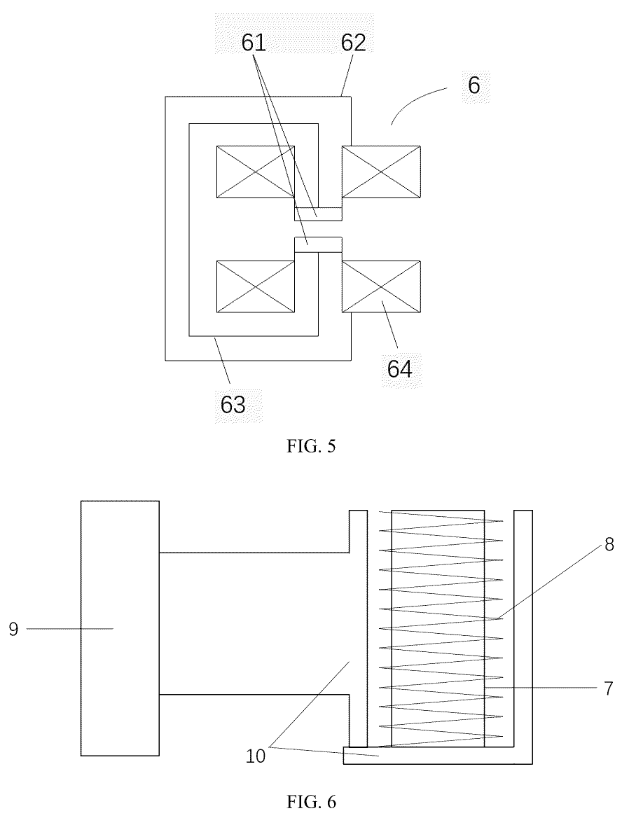

FIG. 3 shows a schematic diagram of the magnetic field orientation device (permanent magnetic orientation) of the extrusion mechanism of the disclosure, and FIG. 4 shows a cross-sectional schematic diagram of the magnetic field orientation device (permanent magnetic orientation). The magnetic field orientation device 5 is provided with two magnetizers 51 and two permanent magnets 52, the permanent magnet 52 is sandwiched between the two magnetizers 51, and the two permanent magnets 52 are respectively located on opposite sides of the extrusion channel 54, and the magnetic field lines generated between the two permanent magnets penetrate the extrusion channel 54 to perform magnetic field orientation on the molten flame-retardant magnetic materials in the extrusion channel 54, and the magnetic field core mold 55 can guide the passage of the wire, so that the wire can pass more smoothly. FIG. 5 shows a schematic diagram of the magnetic field orientation device (electromagnetic orientation) of the extruder head of the disclosure, comprising an electromagnet 6 and a magnetic field core mold (not shown in the figure), the N pole and the S pole of the electromagnet 6 are arranged relative to each other, and there is a gap between the N pole and the S pole of the electromagnet 6. Specifically, the electromagnet 6 is in a ring shape with a gap, so that the N pole and the S pole of the electromagnet 6 are arranged relative to each other, and the N pole and the S pole of the electromagnet 6 are respectively connected to the magnetic pole heads 61 which are trapezoidal to strengthen the magnetic concentration effect. The upper ends of the two magnetic pole heads 61 are soft iron poles 62 and magnetic materials (i.e., yoke iron 63) in turn. The magnetic materials are connected to form a magnetic field loop. Coils 64 are arranged on both sides of each magnetic pole, and the magnetic field lines of the coils 64 on both sides of the same magnetic pole are in the same direction. In the case of externally wrapped materials such as TPU, TPEE, TPV, etc., after the aforementioned middle sheath layer is extruded, the outer sheath layer is extruded and wrapped by a double-layer extrusion device. In the case of externally wrapped braided materials, the outer sheath layer of braided layer is prepared by a braiding device.

If necessary, the wire curling shape can be initially shaped by baking equipment.

When silicone gel or silicone rubbers are used as the elastic substrate of the middle sheath layer, after the magnet powder is the surface modified, the magnet powders, processing aids and flame retardants are mixed in the aforementioned proportions, and the vulcanizer is added according to the conventional process. After uniformly mixing the materials, the wire is directly extruded at room temperature by using a single-screw extruder with a magnetic field orientation function, and vulcanized and shaped through a heating channel at a temperature of 200˜400° C.

The wire is magnetized in a curled state by using a spiral coil magnetizing device with a magnetic field strength of more than 35000 kOe and is magnetized in a flat state by using a groove magnetizing device. After preparation, the surface magnetic field strength of the wire in the magnetization direction is more than 500 Gs.

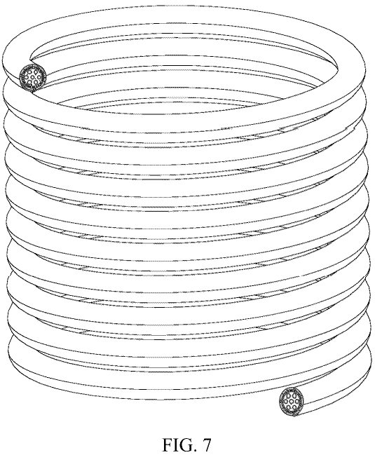

FIG. 6 shows a schematic diagram of a magnetization scheme for the flame-retardant magnetic wire of the disclosure. The wire 8 to be magnetized is coiled on the solenoid cylinder 7, fixed by a clamp 10 and magnetized by a magnetizing machine 9. The surface magnetic field strength of the magnetized wire in the magnetization direction is above 500 Gs, so that it can be stored conveniently. FIG. 7 shows a schematic diagram of the storage effect of the flame-retardant magnetic wire of the disclosure.

The disclosure has no special restrictions on the sources of all raw materials. Unless otherwise specified, they are all conventional products that can be obtained commercially.

SmFeN magnet powder was purchased from Ningxia Magvalley Noval Materials Technology Co., Ltd.

Ferrite powder was purchased from Zhejiang Dongci Toda Magnetics Co., Ltd.

TPV, model 1190A-S0204, was purchased from GLS Corporation, USA.

TPEE, model SHF 50A-3S1981, was purchased from GLS Corporation, USA.

TPU, model Elastollan SP1150A15P, was purchased from BASF.

Silicone rubber, model 107 room temperature vulcanized silicone rubber, was purchased from Jinan Yingyu Chemical Co., Ltd.

PVC, model S080 PR-640, was purchased from Ningbo Formosa Plastics.

The core used in the following examples was a halogen-free flame-retardant five-core wire, which is covered with an insulation layer.

The ferrite powder used in the following examples was anisotropic.

### Example 1

Anisotropic SmFeN magnet powders (D50 of 2.05 μm) and ferrite magnet powders (D50 of 1.64 μm) were modified respectively by using the silane coupling agent KH550 in an amount of 1.5 wt % of the magnet powders, comprising: dissolving KH550 silane coupling agent in anhydrous ethanol (silane coupling agent concentration of 20 wt %), adding magnet powders, mixing, stirring and drying at 110° C. through a Hensel mixing-dryer to obtain the modified anisotropic SmFeN magnet powders and the modified ferrite magnet powders.

45 wt % of the modified anisotropic samarium iron nitrogen magnet powders, 20 wt % of modified ferrite magnet powders, 20 wt % of TPV (melting point 170° C.), 10 wt % of phosphorus nitrogen halogen-free flame retardant KSW-03, and 5 wt % of additives containing antioxidants and plasticizers (including 2 wt % of antioxidant 1076 and 3 wt % of plasticizer DEHP) were fully mixed, and magnetic particles were prepared by using a twin-screw extruder at the screw temperature of each section of 100˜200° C.

A single screw wire extruder was used to extrude the middle sheath layer of the halogen-free flame-retardant magnetic wire through an extruder head, which was orientated by a permanent magnet at the magnetic field strength of 12000 Oe. It had an oblate cross-section shape, and the extrusion speed was 30 m/s. The screw temperature of each section of the extruder was 100˜200° C., and the die temperature was 150° C. The thickness of the middle sheath layer was 0.6 mm.

The flame retardant chinlon woven outer sheath was prepared by using a weaving device, and the thickness of the outer sheath layer was 0.3 mm.

The curled shape of the wire was initially shaped by a baking equipment at a baking temperature of 280° C.

The wire was magnetized in a coiled state by using a spiral coil magnetizing device with a magnetic field strength of 35000 kOe.

The magnetic data cable had a core diameter of 2.8 mm, the finished height of the wire section of 4.6 mm, the width of the flat part of 0.5 mm, the width of the wire section of 4.8 mm, and the Shore hardness of 70 A. After magnetization, the measured surface magnetic field strength of the flat part was 650 Gs. The flame-retardant rating of the finished wire was tested by using a cable flame-retardant testing equipment according to the UL1581 standard, which was VW−1.

### Example 2

Anisotropic SmFeN magnet powders (D50 of 2.1 μm) and ferrite magnet powders (D50 of 1.75 μm) were modified respectively by using the silane coupling agent KH550 in an amount of 2 wt % of the magnet powder, comprising: dissolving KH550 silane coupling agent in anhydrous ethanol (silane coupling agent concentration of 20 wt %), adding magnet powders, mixing, stirring and drying at 130° C. through a Hensel mixing-dryer to obtain the modified anisotropic SmFeN magnet powders and the modified ferrite magnet powders.

48 wt % of the modified anisotropic samarium iron nitrogen magnet powders, 22 wt % of the modified ferrite magnet powder, 20 wt % of TPEE (melting point of 150° C.), 5 wt % of the halogen-free flame retardant aluminum hydroxide, and 5 wt % of additives containing antioxidants and toughening agents (including 2 wt % of antioxidant 1076 and 3 wt % of toughening agent DEHP) were fully mixed, and magnetic particles were prepared by using a twin-screw extruder at the screw temperature of each section of 100˜200° C.

A single screw wire extruder was used to extrude the middle sheath layer of the halogen-free flame-retardant magnetic wire through an extruder head, which was orientated at an electromagnetic field having the magnetic field strength of 14000 Oe. It had a round cross-section shape, and the extrusion speed was 30 m/s. The screw temperature of each section of the extruder was 100˜200° C., and the die temperature was 180° C. The thickness of the middle sheath layer was 0.5 mm.

The outer sheath layer of the halogen-free flame-retardant TPEE was extruded through a double-layer extrusion device, which had the thickness of 0.3 mm.

The curled shape of the wire was initially shaped by a baking equipment at a baking temperature of 280° C.

The wire was magnetized in a coiled state by using a spiral coil magnetizing device with a magnetic field strength of 35000 kOe.

The magnetic data cable had a core diameter of 2.8 mm, and the cross-section diameter of 4.4 mm, and the Shore hardness of 80 A. After magnetization, the measured surface magnetic field was 750 Gs. The flame-retardant rating of the finished wire was tested by using a cable flame-retardant testing equipment according to the UL1581 standard, which was VW−1.

### Example 3

Anisotropic SmFeN magnet powders (D50 of 2.3 μm) and ferrite magnet powders (D50 of 1.68 μm) were modified respectively by using silane coupling agent KH550 in an amount of 0.5 wt % of the magnet powders, comprising: dissolving KH550 silane coupling agent in anhydrous ethanol (silane coupling agent concentration of 20 wt %), adding magnet powders, mixing, stirring and drying at 80° C. through a Hensel mixing-dryer to obtain the modified anisotropic SmFeN magnet powders and the modified ferrite magnet powders.

48 wt % of the modified anisotropic samarium iron nitrogen magnet powders, 25 wt % of the modified ferrite magnet powders, 15 wt % of TPU (melting point of 200° C.), 7 wt % of magnesium hydroxide halogen-free flame retardant, and 5 wt % of additives containing antioxidants, toughening agents, and lubricants (including 2 wt % of antioxidant 1076, 2 wt % of toughening agent DEHP, and 1 wt % of lubricant PMX-200) were fully mixed, and magnetic particles were prepared by using a twin-screw extruder at the screw temperature of each section of 100˜200° C.

A single screw wire extruder was used to extrude the middle sheath layer of the halogen-free flame-retardant magnetic wire through an extruder head, which was orientated at an electromagnetic field having the magnetic field strength of 14000 Oe. It had a rectangular cross-section shape, and the extrusion speed was 30 m/s. The screw temperature of each section of the extruder was 100˜200° C., and the die temperature was 180° C. The thickness of the middle sheath layer was 0.8 mm.

The flame retardant aramid woven outer sheath was prepared by using a weaving device, and the thickness of the outer sheath layer was 0.3 mm.

The curled shape of the wire was initially shaped by a baking equipment at a baking temperature of 280° C.

The flat magnetization was performed along the height direction of the wire by using a groove magnetizing device with a magnetic field strength of 35000 kOe and a pole width interval of 10 mm.

The magnetic data cable had the laid flatly core with a width of 4 mm and a height of 1.5 mm. The finished width of the wire section was 5 mm, the height was 3.7 mm, and the Shore hardness was 90 A. After magnetization, the measured surface magnetic field in the height direction was 850 Gs. The flame-retardant rating of the finished wire was tested by using a cable flame-retardant testing equipment according to the UL1581 standard, which was VW−1.

### Example 4

Anisotropic SmFeN magnet powders (D50 of 2.78 μm) and ferrite magnet powders (D50 of 1.73 μm) were modified respectively by using silane coupling agent KH550 in an amount of 1.3 wt % of the magnet powder weight, comprising: dissolving KH550 silane coupling agent in anhydrous ethanol (silane coupling agent concentration of 20 wt %), adding magnet powders, mixing, stirring and drying at 110° C. through a Hensel mixing-dryer to obtain the modified anisotropic SmFeN magnet powders and the modified ferrite magnet powders.

45 wt % of the modified anisotropic samarium iron nitrogen magnet powders, 20 wt % of the modified ferrite magnet powder, 20 wt % of silicone rubber, 10% of phosphorus-nitrogen flame retardant KSW-03, and 4.5% of additives containing antioxidants and plasticizers (including 2 wt % of antioxidant 1076 and 2.5 wt % of plasticizer DEHP) were fully mixed, and then 0.5 wt % of vulcanizer TMTD was added. The mixture was mixed evenly at room temperature using an internal mixer. A single screw wire extruder was used to extrude the middle sheath layer of the halogen-free flame-retardant magnetic wire through an extruder head, which was orientated by a permanent magnet at the magnetic field strength of 12000 Oe. It had an oblate cross-section shape, and the extrusion speed was 30 m/s. The extruder screw and die head were not heated up. The thickness of the middle sheath layer was 0.8 mm. After the wire was extruded, it was vulcanized and shaped in a 300° C. heating channel.

The wire was magnetized in a coiled state by using a spiral coil magnetizing device with a magnetic field strength of 35000 kOe.

The magnetic data cable had a core diameter of 2.8 mm, the finished height of the wire section of 4.4 mm, the width of the flat part of 0.5 mm, the width of the wire section of 4.6 mm, and the Shore hardness of 70 A. After magnetization, the measured surface magnetic field strength of the flat part was 700 Gs. The flame-retardant rating of the finished wire was tested by using a cable flame-retardant testing equipment according to the UL1581 standard, which was VW−1.

### Example 5

Anisotropic SmFeN magnet powders (D50 of 2.53 μm) and ferrite magnet powder (D50 of 1.65 μm) were modified respectively by using silane coupling agent KH550 in an amount of 1.5 wt % of the magnet powders, comprising: dissolving KH550 silane coupling agent in anhydrous ethanol (silane coupling agent concentration of 20 wt %), adding magnet powders, mixing, stirring and drying at 130° C. through a Hensel mixing-dryer to obtain the modified anisotropic SmFeN magnet powders and the modified ferrite magnet powders.

48 wt % of the modified anisotropic samarium iron nitrogen magnet powders, 22 wt % of the modified ferrite magnet powders, 15 wt % of TPEE (melting point of 150° C.), 5 wt % of PVC (melting point of 200° C.), 5 wt % of halogen-free flame retardant aluminum hydroxide, and 5% of additives containing antioxidants and toughening agents (including 2 wt % of antioxidant 1076 and 3 wt % of toughening agent DEHP) were fully mixed, and magnetic particles were prepared by using a twin-screw extruder at the screw temperature of each section of 100˜200° C.

A single screw wire extruder was used to extrude the middle sheath layer of the halogen-free flame-retardant magnetic wire through an extruder head, which was orientated at an electromagnetic field having the magnetic field strength of 14000 Oe. It had a round cross-section shape, and the extrusion speed was 30 m/s. The screw temperature of each section of the extruder was 100˜200° C., and the die temperature was 180° C. The thickness of the middle sheath layer was 0.6 mm.

The outer sheath layer of the halogen-free flame-retardant TPEE was extruded through a double-layer extrusion device, which had the thickness of 0.3 mm.

The curled shape of the wire was initially shaped by a baking equipment at a baking temperature of 280° C.

The wire was magnetized in a coiled state by using a spiral coil magnetizing device with a magnetic field strength of 35000 kOe.

The magnetic data cable had a core diameter of 3.0 mm, and the cross-section diameter of 4.6 mm, and the Shore hardness of 90 A. After magnetization, the measured surface magnetic field was 800 Gs. The flame-retardant rating of the finished wire was tested by using a cable flame-retardant testing equipment according to the UL1581 standard, which was VW−1.

### Example 6

Anisotropic SmFeN magnet powders (D50 of 1.95 μm) were modified by using a silane coupling agent KH550 in an amount of 2 wt % of the magnet powder, comprising: dissolving KH550 silane coupling agent in anhydrous ethanol (silane coupling agent concentration of 20 wt %), adding magnet powders, mixing, stirring and drying at 110° C. through a Hensel mixing-dryer to obtain the modified anisotropic SmFeN magnet powders.

55 wt % of the modified anisotropic samarium iron nitrogen magnet powders, 20 wt % of TPV (melting point of 170° C.), 20 wt % of phosphorus-nitrogen halogen-free flame retardant KSW-03, and 5 wt % of additives containing antioxidants and plasticizers (including 2 wt % of antioxidant 1076 and 3 wt % of plasticizer DEHP) were fully mixed, and magnetic particles were prepared by using a twin-screw extruder at the screw temperature of each section of 100˜200° C.

A single screw wire extruder was used to extrude the middle sheath layer of the halogen-free flame-retardant magnetic wire through an extruder head, which was orientated by a permanent magnet at the magnetic field strength of 12000 Oe. It had an oblate cross-section shape, and the extrusion speed was 30 m/s. The screw temperature of each section of the extruder was 100˜200° C., and the die temperature was 150° C. The thickness of the middle sheath layer was 0.6 mm.

The flame retardant chinlon woven outer sheath was prepared by using a weaving device, and the thickness of the outer sheath layer was 0.3 mm.

The curled shape of the wire was initially shaped by a baking equipment at a baking temperature of 280° C.

The wire was magnetized in a coiled state by using a spiral coil magnetizing device with a magnetic field strength of 35000 kOe.

The magnetic data cable had a core diameter of 2.8 mm, the finished height of the wire section of 4.6 mm, the width of the flat part of 0.5 mm, the width of the wire section of 4.8 mm, and the Shore hardness of 65 A. After magnetization, the measured surface magnetic field strength of the flat part was 700 Gs. The flame-retardant rating of the finished wire was tested by using a cable flame-retardant testing equipment according to the UL1581 standard, which was VW−1.

### Example 7

Anisotropic SmFeN magnet powders (D50 of 2.15 μm) and ferrite magnet powders (D50 of 1.70 μm) were modified respectively by using silane coupling agent KH550 in an amount of 0.5 wt % of the magnet powder, comprising: dissolving KH550 silane coupling agent in anhydrous ethanol (silane coupling agent concentration of 20 wt %), adding magnet powders, mixing, stirring and drying at 110° C. through a Hensel mixing-dryer to obtain the modified anisotropic SmFeN magnet powders and the modified ferrite magnet powders.

35 wt % of the modified anisotropic samarium iron nitrogen magnet powders, 35 wt % of the modified ferrite magnet powders, 20 wt % of TPV (melting point of 170° C.), 5 wt % of phosphorus-nitrogen halogen-free flame retardant KSW-03, and 5 wt % of additives containing antioxidants and plasticizers (including 2 wt % of antioxidant 1076 and 3 wt % of plasticizer DEHP) were fully mixed, and magnetic particles were prepared by using a twin-screw extruder at the screw temperature of each section of 100˜200° C.

A single screw wire extruder was used to extrude the middle sheath layer of the halogen-free flame-retardant magnetic wire through an extruder head, which was orientated by a permanent magnet at the magnetic field strength of 12000 Oe. It had an oblate cross-section shape, and the extrusion speed was 30 m/s. The screw temperature of each section of the extruder was 100˜200° C., and the die temperature was 150° C. The thickness of the middle sheath layer was 0.6 mm.

The flame retardant chinlon woven outer sheath was prepared by using a weaving device, and the thickness of the outer sheath layer was 0.3 mm.

The curled shape of the wire was initially shaped by a baking equipment at a baking temperature of 280° C.

The wire was magnetized in a coiled state by using a spiral coil magnetizing device with a magnetic field strength of 35000 kOe.

The magnetic data cable had a core diameter of 2.8 mm, the finished height of the wire section of 4.6 mm, the width of the flat part of 0.5 mm, the width of the wire section of 4.8 mm, and the Shore hardness of 70 A. After magnetization, the measured surface magnetic field strength of the flat part was 550 Gs. The flame-retardant rating of the finished wire was tested by using a cable flame-retardant testing equipment according to the UL1581 standard, which was VW−1.

### Example 8

Anisotropic NdFeN magnet powders (D50 of 1.65 μm) and ferrite magnet powders (D50 of 1.70 μm) were modified respectively by using KH550 silane coupling agent in an amount of 1.5 wt % of the magnet powders, comprising: dissolving KH550 silane coupling agent in anhydrous ethanol (silane coupling agent concentration of 20 wt %), adding magnet powders, mixing, stirring and drying at 120° C. through a Hensel mixing-dryer to obtain the modified anisotropic NdFeN magnet powders and the modified ferrite magnet powders.

55 wt % of modified anisotropic NdFeN magnet powders, 15 wt % of modified ferrite magnet powders, 20 wt % of TPV (melting point of 170° C.), 5 wt % of phosphorus-nitrogen halogen-free flame retardant KSW-03, and 5 wt % of additives containing antioxidants and plasticizers (including 2 wt % of antioxidant 1076 and 3 wt % of plasticizer DEHP) were fully mixed, and magnetic particles were prepared by using a twin-screw extruder at the screw temperature of each section of 100˜200° C.

A single screw wire extruder was used to extrude the middle sheath layer of the halogen-free flame-retardant magnetic wire through an extruder head, which was orientated by a permanent magnet at the magnetic field strength of 12000 Oe. It had an oblate cross-section shape, and the extrusion speed was 30 m/s. The screw temperature of each section of the extruder was 100˜200° C., and the die temperature was 150° C. The thickness of the middle sheath layer was 0.8 mm.

The flame retardant chinlon woven outer sheath was prepared by using a weaving device, and the thickness of the outer sheath layer was 0.3 mm.

The curled shape of the wire was initially shaped by a baking equipment at a baking temperature of 280° C.

The wire was magnetized in a coiled state by using a spiral coil magnetizing device with a magnetic field strength of 35000 kOe.

The magnetic data cable had a core diameter of 2.8 mm, the finished height of the wire section of 5.0 mm, the width of the flat part of 0.7 mm, the width of the wire section of 5.2 mm, and the Shore hardness of 65 A. After magnetization, the measured surface magnetic field strength of the flat part was 550 Gs. The flame-retardant rating of the finished wire was tested by using a cable flame-retardant testing equipment according to the UL1581 standard, which was VW−1.

### Comparative Example 1

The material in Example 1 was extruded through a die without a magnetic field orientation function, and the other processes were exactly identical to Example 1. After the magnetization, the measured surface magnetic field strength of the flat part was 280 Gs, and the Shore hardness was 70 A. The flame-retardant rating of the finished wire was tested by using a cable flame-retardant testing equipment according to the UL1581 standard, which was VW−1.

### Comparative Example 2

The magnet powders (SmFeN magnet powders and ferrite magnet powder) in Example 1 were all replaced by the isotropic NdFeB magnet powders (D50 of 103 μm), the material was extruded through a die head without magnetic field orientation function, and the other processes were exactly identical to Example 1. After the magnetization, the measured surface magnetic field strength of the flat part was 480 Gs, and the Shore hardness was 90 A. The flame-retardant rating of the finished wire was tested by using a cable flame-retardant testing equipment according to the UL1581 standard, which was failed.

### Comparative Example 3

The mixture in Example 1 was changed as follows: 45 wt % of modified isotropic samarium iron nitrogen magnet powders, 15% of modified ferrite magnet powders, 20% of TPV, 15% of phosphorus-nitrogen halogen-free flame retardant, and 5% of additives containing antioxidants and plasticizers, and fully mixed, and extruded through a die head without magnetic field orientation function. The other processes were exactly identical to Example 1. After the magnetization, the measured surface magnetic field strength of the flat part was 450 Gs, and the Shore hardness was 90 A. The flame-retardant rating of the finished wire was tested by using a cable flame-retardant testing equipment according to the UL1581 standard, which was failed.

### Comparative Example 4

The flame retardant in the mixture in Example 1 was replaced with anisotropic samarium iron nitrogen magnet powders, that is, 55 wt % of modified anisotropic samarium iron nitrogen magnet powder, 20% of modified ferrite magnet powder, 20% of TPV, and 5% of additives containing antioxidants and plasticizers were fully mixed. The other processes were exactly identical to Example 1.

After the magnetization, the measured surface magnetic field strength of the flat part was 700 Gs, and the Shore hardness was 85 A. The flame-retardant rating of the finished wire was tested by using a cable flame-retardant testing equipment according to the UL1581 standard, which was failed.

### Comparative Example 5

The anisotropic samarium iron nitrogen magnet powder and ferrite magnet powder in Example 1 were not modified by KH550 silane coupling agent, and the other processes were exactly identical to Example 1. After the magnetization, the measured surface magnetic field strength of the flat part was 400 Gs, and the Shore hardness was 90 A. The flame-retardant rating of the finished wire was tested by using a cable flame-retardant testing equipment according to the UL1581 standard, which was VW−1.

### Comparative Example 6

86.5 wt % of anisotropic SmFeN magnet powder, 11 wt % of TPU, and 2.5 wt % of antioxidant and lubricant were fully mixed, and a twin-screw extruder was used to prepare the granular material for middle sheath layer. The anisotropic SmFeN magnet powder had D50 of 4 μm.

86.5 wt % of the powders including fillers and pigments, 11 wt % of TPU, 2.5 wt % of additives containing phosphorus-nitrogen flame retardant KSW-03, antioxidant 1076 and lubricant PMX-200 silicone oil (mass ratio of 1:1:1) were fully mixed, and the outer sheath layer granules were prepared by using a twin-screw extruder.

A single-screw wire extruder was used to extrude the middle sheath layer granules, and a double-layer extrusion device was used to extrude the outer sheath layer granules.

It had the core diameter of 2.8 mm, the middle sheath thickness of 0.7 mm, and the outer sheath thickness of 0.4 mm. The wire was magnetized in a coiled state by using a spiral coil magnetizing device.

After the magnetization, the measured surface magnetic field strength of the wire was 200 Gs, and the Shore hardness was 95 A. The flame-retardant rating of the finished wire was tested by using a cable flame-retardant testing equipment according to the UL1581 standard, which was failed.

The wires in Examples 1-8 and Comparative Examples 1-6 were subjected to high temperature winding and cold bending experiments respectively.

High temperature winding testing conditions: 100° C./1 hour, the diameter of the winding mandrel was twice the outer diameter of the wire, observing whether the wire has cracking defects: it is qualified if there is no cracking defects, and it is unqualified if there are cracking defects.

Cold bending test testing conditions:−20° C./4 hours, the diameter of the winding mandrel was twice the outer diameter of the wire, observing whether the wire has cracking defects: it is qualified if there is no cracking defects, and it is unqualified if there are cracking defects.

The testing results were shown in Table 1 below:

TABLE 1

| | surface | Flame | | High | Cold |
|---|---|---|---|---|---|
| | magnetic | retardant | | temperature | bending |
| | field strength | testing | hardness | winding | testing |
| Example 1 | 650 Gs | VW-1 | 70 A | qualified | qualified |
| Example 2 | 750 Gs | VW-1 | 80 A | qualified | qualified |
| Example 3 | 850 Gs | VW-1 | 90 A | qualified | qualified |
| Example 4 | 700 Gs | VW-1 | 70 A | qualified | qualified |
| Example 5 | 800 Gs | VW-1 | 90 A | qualified | qualified |
| Example 6 | 700 Gs | VW-1 | 65 A | qualified | qualified |
| Example 7 | 550 Gs | VW-1 | 70 A | qualified | qualified |
| Example 8 | 550 Gs | VW-1 | 65 A | qualified | qualified |
| Comparative | 280 Gs | VW-1 | 70 A | qualified | qualified |
| Example 1 | | | | | |
| Comparative | 480 Gs | Failed | 90 A | unqualified | unqualified |
| Example 2 | | | | | |
| Comparative | 450 Gs | Failed | 90 A | unqualified | unqualified |
| Example 3 | | | | | |
| Comparative | 700 Gs | Failed | 85 A | qualified | qualified |
| Example 4 | | | | | |
| Comparative | 400 Gs | VW-1 | 90 A | unqualified | unqualified |
| Example 5 | | | | | |
| Comparative | 200 Gs | Failed | 95 A | unqualified | unqualified |
| Example 6 | | | | | |

It can be seen from the above results that all the wires prepared in Examples 1-8 of the disclosure have good flame retardant properties and high surface magnetic field strength, and exhibit excellent mechanical properties in high temperature winding and cold bending testing. The material for the flame-retardant magnetic layer of the Comparative example 1 is extruded through a die head without magnetic field orientation function, which results in low surface magnetic field strength and cannot meet the magnetic attraction requirements of the wire. Compared with the technical solution of compounding anisotropic SmFeN magnet powder and ferrite magnet powder in Example 1, the poor flame retardant effect and the poor mechanical properties are achieved in the Comparative example 2, where the isotropic NdFeB magnet powder are used as the magnetic material. Isotropic SmFeN magnet powder and a high amount of flame retardant are used in the Comparative example 3, but the obtained wire has a low surface magnetic field strength, and the flame retardant effect and mechanical properties cannot reach the level of the Examples. Comparative example 4 does not contain the flame retardant and fails the flame retardant test. The anisotropic SmFeN magnet powder and ferrite magnet powder of Comparative example 5 are not modified with the coupling agents, but the surface magnetic field strength is only 400 Gs, and the magnetic properties fail to reach the level of the Examples and the mechanical properties are unqualified. Comparative example 6 adopts the method disclosed in the prior art CN 113674921B, and SmFeN magnet powder with D50 of 4 μm is used as the magnetic material, and the flame retardant is only contained in the outer sheath layer. Since the anisotropic SmFeN magnet powder used in Comparative Example 6 has a too large D50 and low magnetic properties, the obtained wire does not have the high magnetic attraction force (surface magnetic field strength of 200 Gs), the poor bonding properties with the elastomer, and too high hardness (95 A), resulting in that the flame retardant and mechanical properties fail to reach the level of the Examples.

The present disclosure has been described above in conjunction with preferred embodiments, but these embodiments are only exemplary and serve only as an illustration. On this basis, various replacements and improvements may be made to the present disclosure, all of which fall within the protection scope of the present disclosure.

1. A method for preparing a flame-retardant magnetic wire, wherein the flame-retardant magnetic wire is provided with a core, a middle sheath layer and an optional outer sheath layer from inside to outside, the middle sheath layer is a flame-retardant magnetic layer,
the method comprising:
(1) co-extruding a core and a material for the flame-retardant magnetic layer to obtain a core coated with the flame-retardant magnetic layer, wherein the material for the flame-retardant magnetic layer comprises an elastic substrate, a magnetic material and a flame retardant; wherein the magnetic material comprises a rare earth iron nitrogen magnet powder, or, the magnetic material comprises a rare earth iron nitrogen magnet powder and a ferrite magnet powder;
optionally, forming an outer sheath layer on the outside of the core coated with the flame-retardant magnetic layer;
(2) shaping the wire obtained in step (1);
(3) magnetizing the wire obtained in step (2) to obtain the flame-retardant magnetic wire;
in the material for the flame-retardant magnetic layer, the content of the elastic substrate is 15 wt %˜25 wt %, the content of the magnetic material is 55 wt %˜75 wt %, and the content of the flame retardant is 5 wt %˜15 wt %.

2. The method according to claim 1, wherein the magnetic material comprises a rare earth iron nitrogen magnet powder and a ferrite magnet powder, and
in the magnetic material, the mass ratio of the rare earth iron nitrogen magnet powder to the ferrite magnet powder is (0.5-1):(0-0.5), and further preferably (0.5-0.9):(0.1-0.5).

3. The method according to claim 2, wherein
the rare earth iron nitrogen magnet powder is a samarium iron nitrogen magnet powder and/or a neodymium iron nitrogen magnet powder;
the samarium iron nitrogen magnet powder has a D50 of 1.9-3 μm, the neodymium iron nitrogen magnet powder has a D50 of 1.5-1.9 μm, and the ferrite magnet powder has a D50 of 1.5-1.8 μm; and/or
the samarium iron nitrogen magnet powder, the neodymium iron nitrogen magnet powder and/or the ferrite magnet powder are anisotropic.

4. The method according to claim 1, wherein, in step (1), the extruder head adopted during the extrusion molding is oriented by a permanent magnet or at an electromagnetic field.

5. The method according to claim 4, wherein
the magnetic field strength for orienting by the permanent magnet is 8000˜13000 Oe; or
the magnetic field strength for orienting at the electromagnetic field is ≥13000 Oe.

6. The method according to claim 1, wherein the elastic substrate is:
a polyvinyl chloride (PVC) having a hardness of 40-100 A;
a silicone rubbers having a hardness of 40-70 A; and/or
a thermoplastic elastomer having a melting point of 80˜200° C. selected from the group consisting of styrene-based thermoplastic elastomers, olefin-based thermoplastic elastomers, diene-based thermoplastic elastomers, vinyl chloride-based thermoplastic elastomers, urethane-based thermoplastic elastomers (TPU), ester-based thermoplastic elastomers (TPEE), amide-based thermoplastic elastomers (TPAE), thermoplastic resins (EEA), thermoplastic vulcanizate (TPV) and silicone-based thermoplastic elastomers.

7. The method according to claim 6, wherein the elastic substrate is one or more halogen-free materials selected from the group consisting of TPEE, TPU, TPV, and TPAE.

8. The method according to claim 1, wherein the flame retardant in the material for the flame-retardant magnetic layer is selected from organic flame retardants and/or inorganic flame retardants; and
the material for the flame-retardant magnetic layer further comprises a processing aid comprising one or more of a coupling agent, a plasticizer, a toughening agent, a lubricant, and an antioxidant.

9. The method according to claim 1, wherein in step (1), the magnetic material is surface-modified with a coupling agent.

10. The method according to claim 1, wherein
the coupling agent is a silane coupling agent or a titanate coupling agent; and
the magnetic material is modified at 80-150° C. by using the coupling agent in an amount of 0.2-2 wt % of the total weight of the magnetic material.

11. The method according to claim 1, wherein in step (1), the outer sheath layer material is selected from one or more of a woven material, TPU, TPEE, TPV, and a silicone rubber, and the woven material is a flame-retardant woven material.

12. The method according to claim 11, wherein the outer sheath layer material is one or more of flame-retardant chinlons, flame-retardant nylons, and flame-retardant aramids.

13. The method according to claim 1, wherein in step (1), the extrusion molding is performed by a single screw wire extruder with a permanent magnet oriented extruder head.

14. The method according to claim 13, wherein
the extrusion speed is ≥30 m/s;
when the elastic substrate is a silicone rubber, the extruder and the die head are at room temperature;
the elastic substrate is a thermoplastic elastomer, and the screw temperature of each section of the extruder is 100-200° C.; and/or
when the elastic substrate is the thermoplastic elastomer, the extruder die temperature is 120-200° C.

15. The method according to claim 1, wherein in step (2), when the elastic substrate is a thermoplastic elastomer, the shaping is performed by baking at 200-300° C.;
in step (2), when the elastic substrate is a silicone rubber, the shaping is performed by vulcanization through a heating channel at a temperature of 200 to 400° C.; and/or
in step (3), the wire is magnetized in a curled state by using a spiral coil magnetizing device with a magnetic field strength of more than 35000 kOe or in a flat state by using a groove magnetizing device.

16. A flame-retardant magnetic wire prepared by the method according to claim 1.

17. The flame-retardant magnetic wire according to claim 16,
the Shore hardness of the wire is ≤90 A;
the flame retardance rating of the wire meets VW−1;
the wire is halogen-free; and/or
the surface magnetic field strength of the wire in the magnetization direction is above 500 Gs.

18. The flame-retardant magnetic wire according to claim 16, wherein the thickness of middle sheath layer of the wire is 0.3-2 mm, and/or the thickness of the outer sheath layer of the wire is ≤1 mm.

19. The flame-retardant magnetic wire according to claim 16, wherein
the core of the wire comprises a single conductor coated with an insulation layer or multiple conductors individually coated with an insulation layer; and
a fiber material is further arranged inside the core of the wire, and the fiber material is selected from one or more of glass fibers, basalt fibers, and aramid fibers.

20. The flame-retardant magnetic wire according to claim 16, wherein
a shielding layer is provided between the core and the middle sheath layer of the wire, and the shielding layer wraps the conductor and the fiber material.
